(19) United States
(12) Patent Application Publication
(10) Pub. No.: US 2014/0301113 A1
(43) Pub. Date: Oct. 9, 2014

(54) SOLAR POWER SUPPLY APPARATUS AND METHOD OF CONTROLLING POWER SUPPLY THEREOF

(71) Applicants: RESEARCH & BUSINESS FOUNDATION SUNGKYUNKWAN UNIVERSITY, Suwon (KR); SAMSUNG ELECTRO-MECHANICS CO., LTD., Suwon (KR)

(72) Inventors: Tae Won LEE, Suwon (KR); Jin Woo JANG, Suwon (KR); Young Hyok JI, Suwon (KR); Young Ho KIM, Seoul (KR); Chung Yuen WON, Anyang (KR); Min Ho HEO, Suwon (KR); Jun Gu KIM, Suwon (KR)

(21) Appl. No.: 13/941,375

(22) Filed: Jul. 12, 2013

(30) Foreign Application Priority Data
Apr. 8, 2013 (KR) 10-2013-0038317

(51) Int. Cl. H02M 3/335

(52) U.S. Cl. CPC H02M 3/33592
USPC 363/21.12

(57) ABSTRACT

There are provided a solar power supply apparatus switching a synchronous rectifying switch instead of a snubber switch to increase power conversion efficiency, and a method of controlling power supply thereof. The solar power supply apparatus includes a power supply unit switching power input by a photovoltaic cell to convert power, synchronously rectifying and outputting the power converted depending on the power conversion switching, and suppressing surplus power generated by the power conversion switching in a snubbing operation; and a control unit controlling the synchronous rectification operation and the snubbing operation of the power supply unit depending on a spike voltage generated by the power conversion switching.

### CROSS-REFERENCE TO RELATED APPLICATIONS

This application claims the priority of Korean Patent Application No. 10-2013-0038317 filed on Apr. 8, 2013, in the Korean Intellectual Property Office, the disclosure of which is incorporated herein by reference.

### BACKGROUND OF THE INVENTION

1. Field of the Invention

The present invention relates to a solar power supply apparatus having increased power conversion efficiency and a method of controlling power supply thereof.

2. Description of the Related Art

As fossil fuels are exhausted and environmental pollution, global warming, and the like, are increasing in severity due to the burning of fossil fuels and carbon dioxide, NOx, SOx, and the like produced thereby, from the end of 20th century, development of and demand for sources of renewable energy have been increased. In particular, the necessity of and demand for technological developments in the field of renewable energy have increased, due to liability for the reduction of greenhouse gas emissions based on the Kyoto Protocol and the increase in crude oil prices. Today, the problem of energy resources is directly connected to national security problems and the willingness to reduce carbon dioxide emissions, as well as technologies to do so, have been recognized as enhancing national competitiveness.

Recently, among various new renewable energy sources, a photovoltaic (PV) cell (solar cell), a source of endless clean energy and a technology that may be implanted with domestic semiconductor technology, has continuously expanded in the domestic market, in spite of the disadvantage of low efficiency. In the case of foreign countries, the commercialization of solar power supply apparatuses using a photovoltaic (PV) cell has been undertaken at the instigation of Japan and Germany, based on long-term accumulated technical skills and the financial ability of those nations.

Generally, a solar power supply apparatus includes a converter converting power output by the photovoltaic (PV) cell into constant DC power and an inverter converting DC power of the converter into commercial AC power. In the above-mentioned converter, power conversion efficiency is one of the most important issues.

### RELATED ART DOCUMENT

Korean Patent Laid-open Publication No. 10-2009-0133036

### SUMMARY OF THE INVENTION

An aspect of the present invention provides a solar power supply apparatus having increased power conversion efficiency by switching a synchronous rectifying switch instead of a snubber switch, and a method of controlling power supply thereof.

According to an aspect of the present invention, there is provided a solar power supply apparatus including: a power supply unit switching power input by a photovoltaic cell to convert power, synchronously rectifying and outputting the power converted depending on the power conversion switching, and suppressing surplus power generated by the power conversion switching in a snubbing operation; and a control unit controlling the synchronous rectification and the snubbing operation of the power supply unit depending on a spike voltage generated by the power conversion switching.

The power supply unit may include: a power switch switching the input power; a snubber switch suppressing the surplus power in a power conversion operation of the power switch; and a synchronous rectifying switch synchronously rectifying the power converted depending on the power conversion operation of the power switch.

The control unit may compare rated voltage of the power switch with the spike voltage depending on the power conversion switching of the power switch and may selectively control an operation of the snubber switch and an operation of the synchronous rectifying switch depending on the compared result.

The control unit may switch the synchronous rectifying switch on when the rated voltage is higher than the spike voltage and may switch the snubber switch on when the rated voltage is lower than the spike voltage.

The control unit may calculate the spike voltage from the input power.

The solar power supply apparatus may further include an inverter unit converting power output by the power supply unit into preset AC power.

A plurality of the power supply units may be connected to each other in parallel and at least some of outputs from the plurality of power supply units connected to each other in parallel may be coupled to each other and may be output.

According to an aspect of the present invention, there is provided a method of controlling solar generated power, the method including: sensing power input by a photovoltaic cell; calculating a spike voltage depending on power conversion switching of a power switch from the input power; and comparing the spike voltage with a rated voltage of the power switch and selectively controlling an operation of a snubber switch suppressing surplus power provided in a power conversion operation of the power switch and an operation of asynchronous rectifying switch synchronously rectifying power converted depending on the power conversion operation of the power switch, depending on the compared result.

In the controlling, the synchronous rectifying switch may be switched on when the rated voltage is higher than the spike voltage and the snubber switch may be switched on when the rated voltage is smaller than the spike voltage.

The power switch, the snubber switch, and the synchronous rectifying switch may be provided with a power supply unit.

The power supply unit may be provided in plural.

At least some of output powers from the plurality of power supply units may be coupled to each other.

The output power from the power supply unit may be converted into preset AC power by an inverter unit further provided therewith.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic configuration diagram of a general solar power supply apparatus;

FIG. 2 is a schematic configuration diagram of a solar power supply apparatus according to an embodiment of the present invention;

FIGS. 3A through 3C are graphs illustrating a voltage of the general solar power supply apparatus and a voltage of the solar power supply apparatus according to the embodiment of the present invention;

FIG. 4 is a schematic block diagram of a control unit adopted in the solar power supply apparatus according to the embodiment of the present invention;

FIGS. 5A and 5B are diagrams illustrating a circuit operation and a voltage waveform of operational voltage of the solar power supply apparatus according to the embodiment of the present invention;

FIG. 6 is an operational flow chart illustrating a power supplying method of the solar power supply apparatus according to the embodiment of the present invention; and

FIGS. 7A through 7H and FIGS. 9A through 9H are diagrams illustrating circuit operations for each operation mode of the solar power supply apparatus according to the embodiment of the present invention and FIGS. 8 and 10 are graphs illustrating signal waveforms of main parts in an operation mode of the solar power supply apparatus according to the embodiment of the present invention.

### DETAILED DESCRIPTION OF THE EMBODIMENTS

Embodiments will now be described in detail with reference to the accompanying drawings.

Embodiments may, however, be embodied in many different forms and should not be construed as being limited to embodiments set forth herein. Rather, these embodiments are provided so that this disclosure will be thorough and complete, and will fully convey the scope of the inventive concept to those skilled in the art.

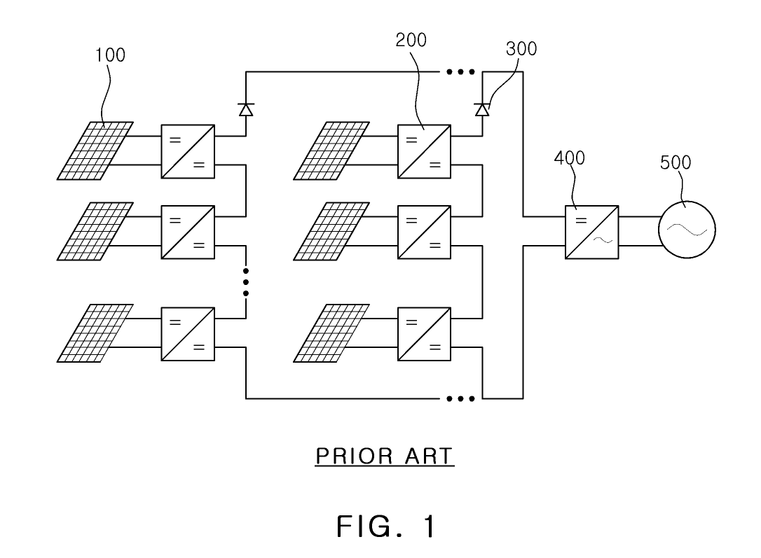

FIG. 1 is a schematic configuration diagram of a general solar power system.

Referring to FIG. 1, the solar power system may generally include a photovoltaic cell 100, a DC-DC power conversion module 200, and a DC-AC power conversion module 400.

The DC power from the photovoltaic cell 100 may be converted into DC power having a preset voltage level by the DC-DC power conversion module 200. The photovoltaic cell 100 and the DC-DC power conversion module 200 may be provided in plural, and the DC power from the plurality of DC-DC power conversion module 200 may respectively be transferred to the DC-AC power conversion module 400 via a blocking diode 300.

The DC-AC power conversion module 400 may convert the transferred DC power into the preset AC power and may provide the converted power to a connected commercial power system 500.

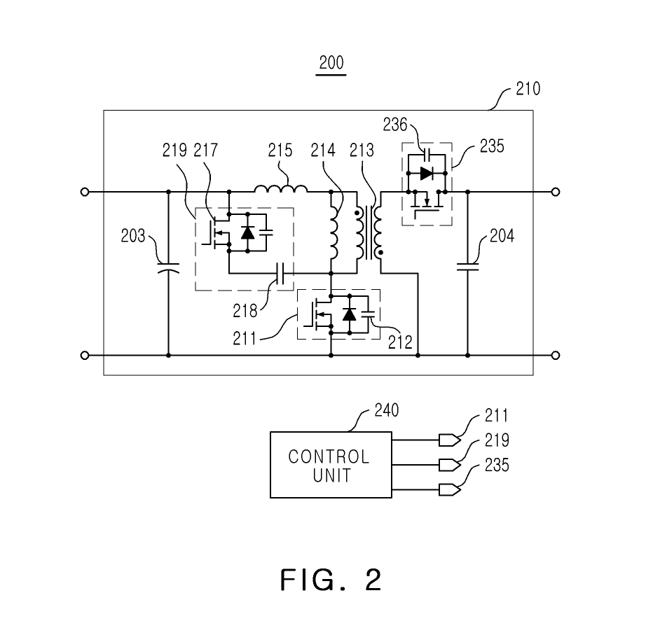

FIG. 2 is a schematic configuration diagram of a solar power supply apparatus according to an embodiment of the present invention.

Referring to FIG. 2, a schematic configuration of the solar power supply apparatus 200 according to the embodiment of the present invention may include a power supply unit 210 and a control unit 240.

The power supply unit 210 may include a power switch 211, a transformer 213, a snubber switch 219, and asynchronous rectifying switch 236.

The power switch 211 may switch power input by the photovoltaic cell through a primary winding of the transformer 213, depending on a control of the control unit 240, and a secondary winding of the transformer 213 may be magnetically coupled to the primary winding such that the power switch 211 may output power depending on a preset turn ratio.

The synchronous rectifying switch 236 may rectify and output the power from the secondary winding in synchronization with the switching of the power switch 211 depending on the control of the control unit 240.

Surplus power may be generated by the power switching of the power switch 211 to excessively increase a voltage stress. In order to improve the problem as described above, the snubber switch 219 to consume the surplus power may be adopted.

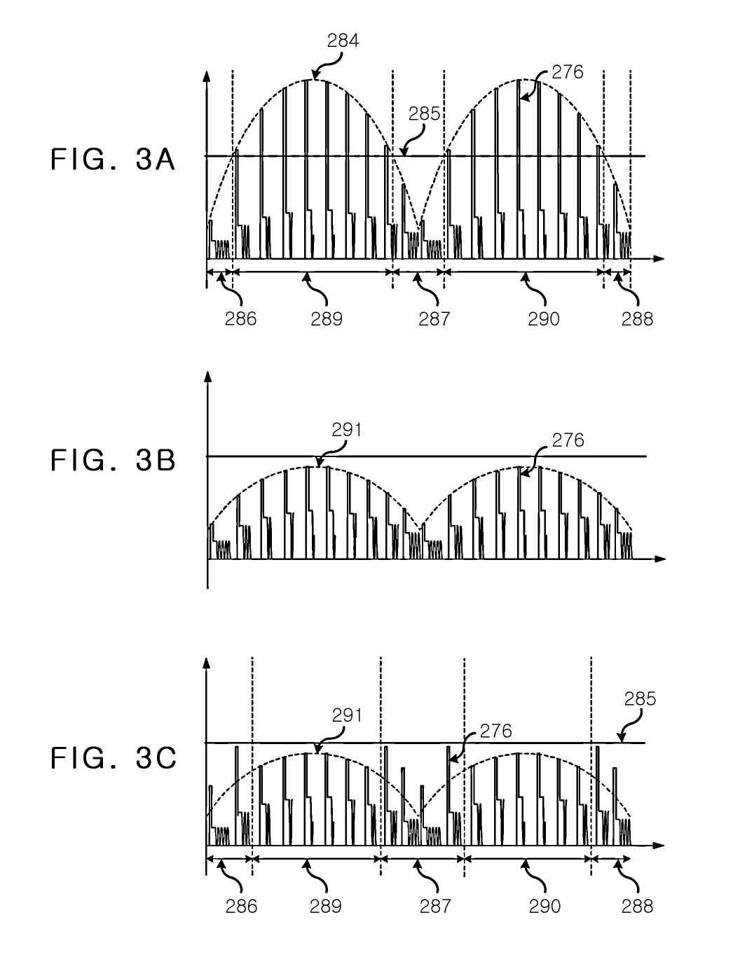

FIGS. 3A through 3C are graphs illustrating a voltage of the general solar power supply apparatus and a voltage of the solar power supply apparatus according to the embodiment of the present invention.

Referring to FIG. 3A, since both-end-voltages of the power switch are larger than a rated voltage 285 of the power switch in high power output periods 286 and 289 among output periods 286, 289, 287, 290, and 288 within a system frequency, in a fly-back type of general solar power supply apparatus in which the snubber switch is not adopted, the power switch may not be operated.

Referring to FIG. 3B, since a maximum voltage waveform 291 of the power switch is lower than the rated voltage 285 over the entire region within the system frequency in the fly-back type of general solar power supply apparatus in which the snubber switch is adopted, the power switch may be operated. However, the power conversion efficiency may be reduced due to the switching loss of the snubber switch over the entire region of the system frequency.

Referring to FIG. 3C, in the solar power supply apparatus according to the embodiment of the present invention, the snubber switch may not be operated, but a snubbing operation may be supplemented by an additional switching control of the synchronous rectifying switch, in the periods 286, 287 and 288 within the system frequency in which the voltage waveform 276 of the power switch is lower than the rated voltage 285, and thus, the snubber switch may only be operated in the regions 289 and 290 in which the voltage waveform 276 excesses the rated voltage of the power switch, thereby reducing switching loss while reducing voltage stress.

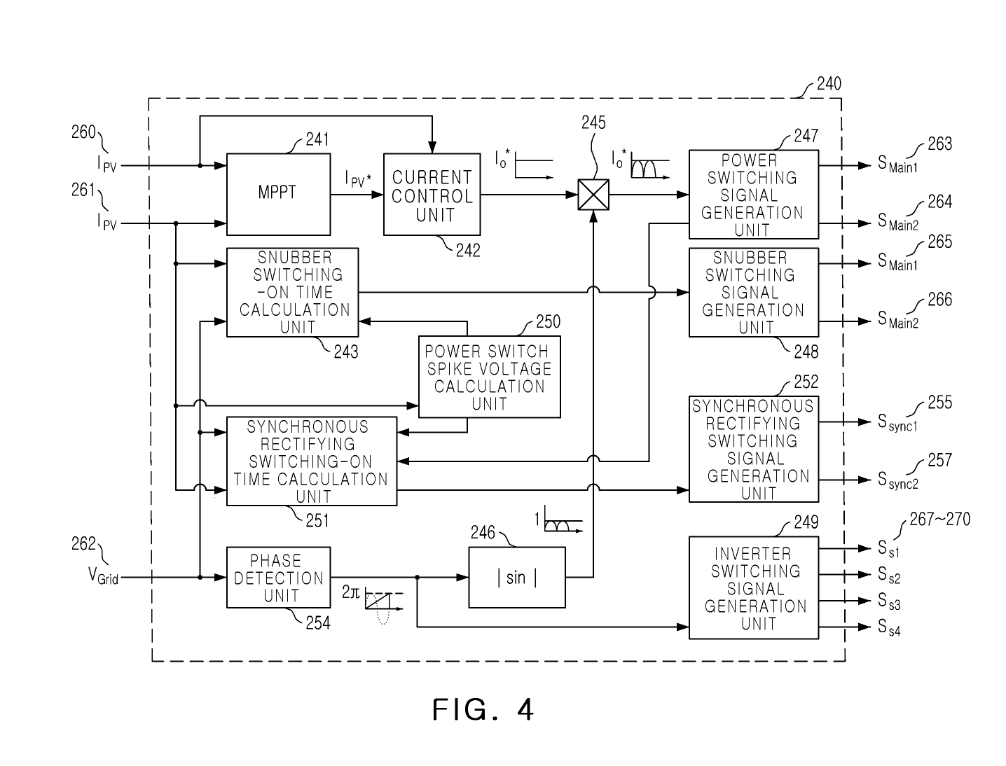

FIG. 4 is a schematic block diagram of a control unit adopted in the solar power supply apparatus according to the embodiment of the present invention.

Referring to FIG. 4, the control unit 240 may include a maximum power point tracker (MPPT) 241, a current control unit 242, a snubber switching-on time calculation unit 243, a phase detection unit 244, a first calculation unit 245, a second calculation unit 246, a power switching signal generation unit 247, a snubber switching signal generation unit 248, a synchronous rectifying switching signal generation unit 252, an inverter switching signal generation unit 249, a power switch spike voltage calculation unit 250, and a synchronous rectifying switching-on time calculation unit 251.

The maximum power point tracker (MPPT) 241 may receive current Ipv and voltage Vpv from the photovoltaic cell to track the maximum power point to control a movement of the photovoltaic cell, and the current control unit 242 may control the current Ipv level from the photovoltaic cell.

The snubber switching-on time calculation unit 243 may calculate the switching-on time of the snubber switch based on the voltage Vpv and a voltage gradient V_{GRID} of the photovoltaic cell.

The phase detection unit 244 may detect a phase from the voltage gradient V_{GRID}, the second calculation unit 246 may calculate an absolute value of a sine value of the detected phase, the first calculation unit 245 may multiply a current value controlled by the current control unit 242 by the calculation value from the second calculation unit 246 and may transfer the multiplied value to the power switching signal generation unit 247, and the power switching signal generation unit 247 may provide power switching signals 263 and 264 to control the switching of the power switch.

The snubber switching signal generation unit 248 provides snubber switching signals 265 and 266, depending on calculations of the snubber switching-on time calculation unit 243 to control the switching of the snubber switch, and the synchronous rectifying switching signal generation unit 252 may provide synchronous rectifying switching signals 255 and 257, depending on results of calculations of the synchronous rectifying switching-on time calculation unit 251 to control the switching of the synchronous rectifying switch.

The synchronous rectifying switching-on time calculation unit 251 may calculate the switching-on time of the synchronous rectifying switch, depending on the voltage gradient V_{GRID} and the power switching signals of the power switching signal generation unit 247, such that the synchronous rectifying switching signals 255 and 257 may be synchronized with the power switching signals 263 and 264.

Meanwhile, the solar power supply apparatus according to the embodiment of the present invention may further include an inverter unit which converts the power output by a power supply unit into preset AC power, such that the control unit 240 may further include an inverter switching signal generation unit 249 controlling the switching of the inverter unit.

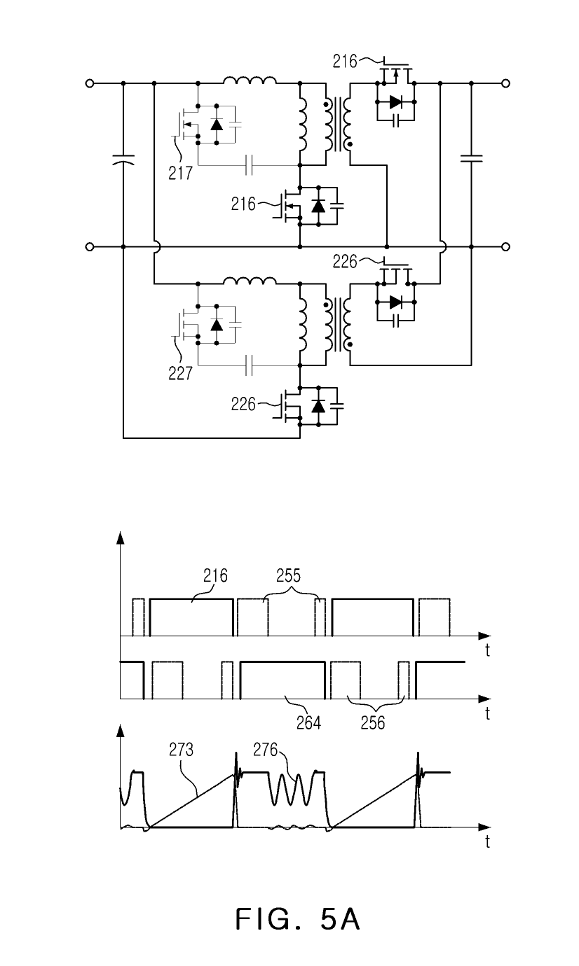

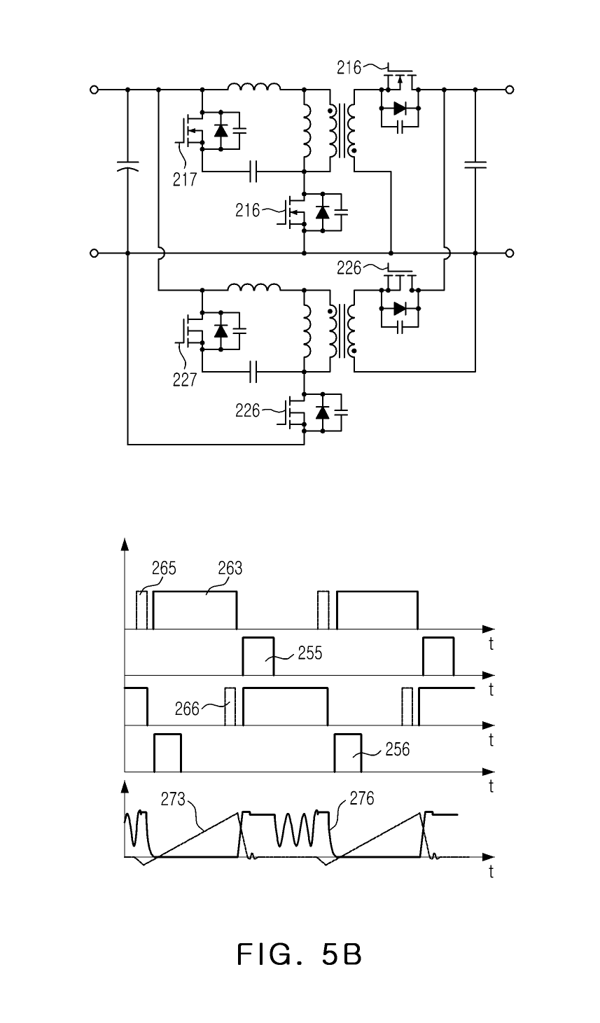

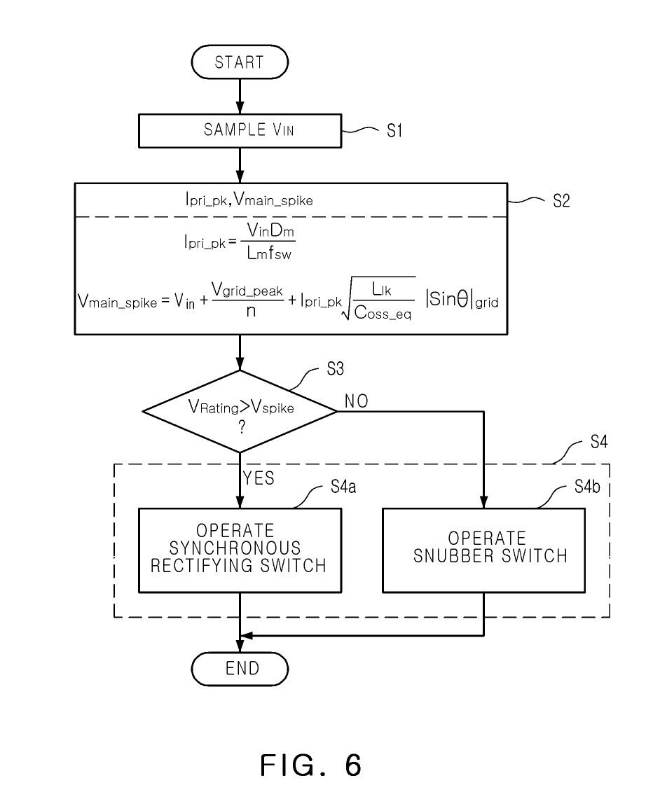

FIGS. 5A and 5B are diagrams illustrating a circuit operation and an operational voltage waveform of the solar power supply apparatus according to the embodiment of the present invention and FIG. 6 is an operational flow chart illustrating a power supplying method of the solar power supply apparatus according to the embodiment of the present invention.

Referring to FIG. 4 along with FIGS. 6, 5A, and 5B, the switching time of the synchronous rectifying switches 235 and 237 and the snubber switches 219 and 229 may be determined depending on the magnitude of spike voltages in both terminals of the power switches 211 and 221, and when snubber switches 219 and 229 are not present, the magnitude of spike voltages applied to both terminals of the power switches 211 and 221 depends on the following Equation 1 (S2).

$${V}_{main\_spike} = {V}_{i n} + \frac{{V}_{grid\_peak}}{n} + {I}_{pri\_peak} \sqrt{\frac{{L}_{lk}}{{C}_{oss\_eq}}} {\vert Sin θ \vert}_{grid} \qquad ( Equation 1 )$$

In the above Equation 1, Iₚᵣᵢ_{_{—}}ₚₑₐₖ refers to a current flowing in the primary winding of the transformer and represents a peak value of current 273 flowing in the power switch, Iₗₖ represents leakage inductances 215 and 225 of the transformer, and Cₒₛₛ_{_{—}}_{eq} represents equivalent output capacitance across both terminals of the power switch.

The Cₒₛₛ_{_{—}}_{eq} is equal to a serial and parallel sum of capacitance Cₒₛₛ_{_{—}}ₘₐᵢₙ of the output capacitor of the power switch, capacitance C_{clamp} of capacitors 218 and 228 of the snubber switch, and capacitance Cₒₛₛ_{_{—}}_{sync} of of output capacitors 236 and 238 of the synchronous rectifying switch, as represented by the following Equation 2. Here, n indicates the turn ratio of the transformer.

$${C}_{oss\_eq} = {C}_{oss\_main} + \frac{{C}_{oss\_clamp} {C}_{clamp}}{{C}_{oss\_clamp} + {C}_{clamp}} + {n}^{2} {C}_{oss\_sync} \qquad ( Equation 2 )$$

The current peak value Iₚᵣᵢ_{_{—}}ₚₑₐₖ flowing in the power switch may be calculated based on the received voltage 261, as represented by the following Equation 3 (S1).

$${I}_{pri\_peak} = \frac{{V}_{i} {D}_{m}}{{L}_{m} {f}_{sw}} \qquad ( Equation 3 )$$

In the above Equation 3, Dₘ represents a maximum value of a switching duty of the power switch and f_{sw} represents a switching frequency of the power switch. Further, Lₘ represents magnetization inductances 214 and 224, a resonance spike voltage calculated depending on Equations 1 to 3 is compared with the rated voltage 285 of the power switch to determine whether the switching operations of the snubber switches 219 and 229 and the synchronous rectifying switches 235 and 237 are performed (S3, S4, S4a, and S4b).

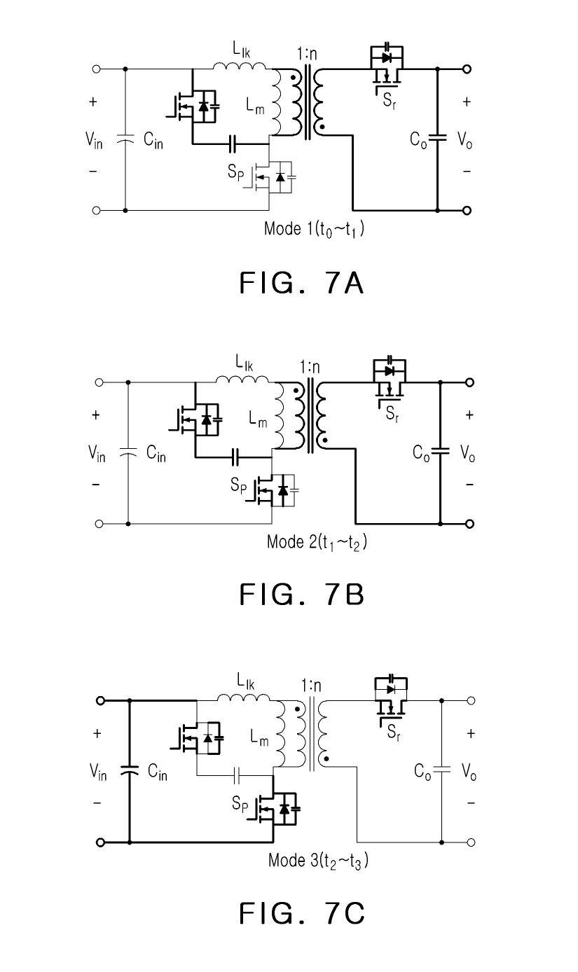

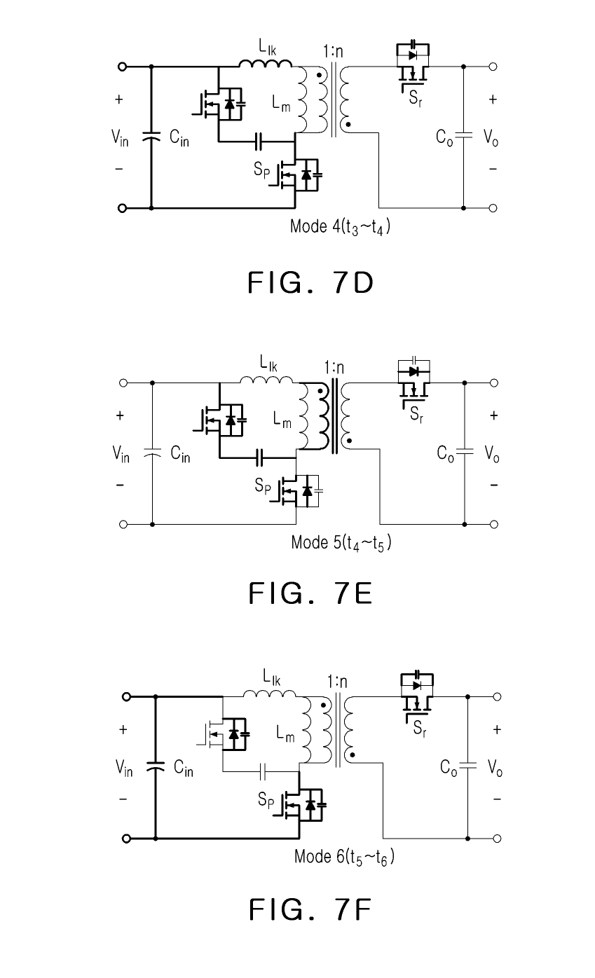

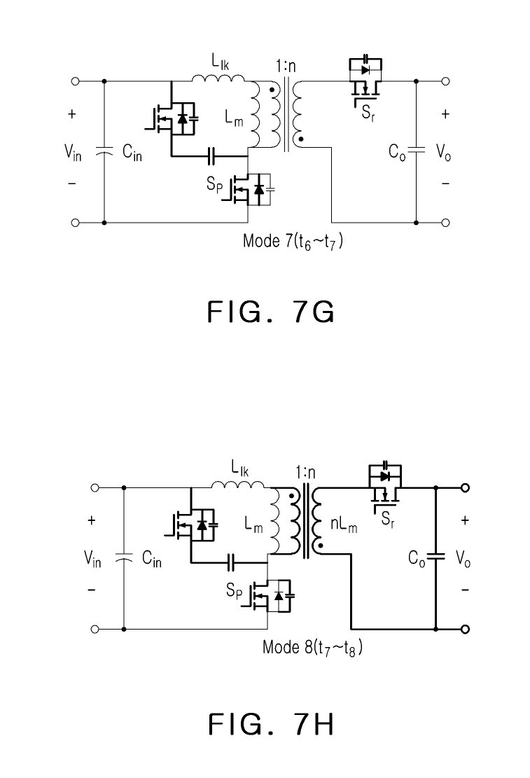

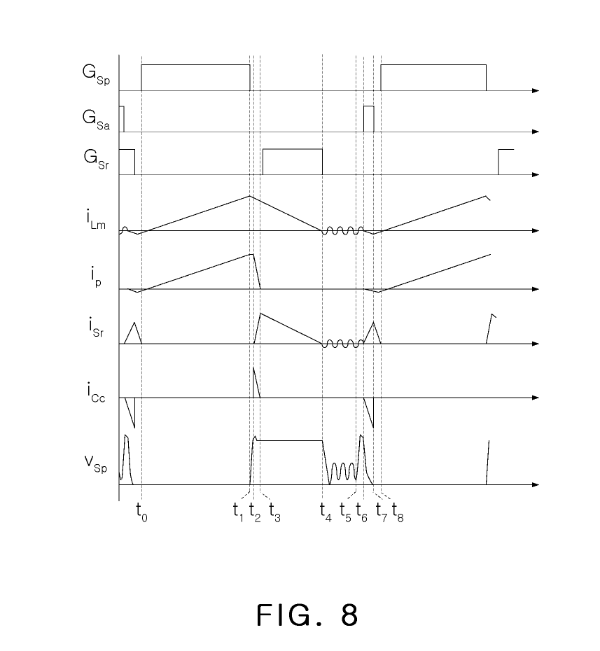

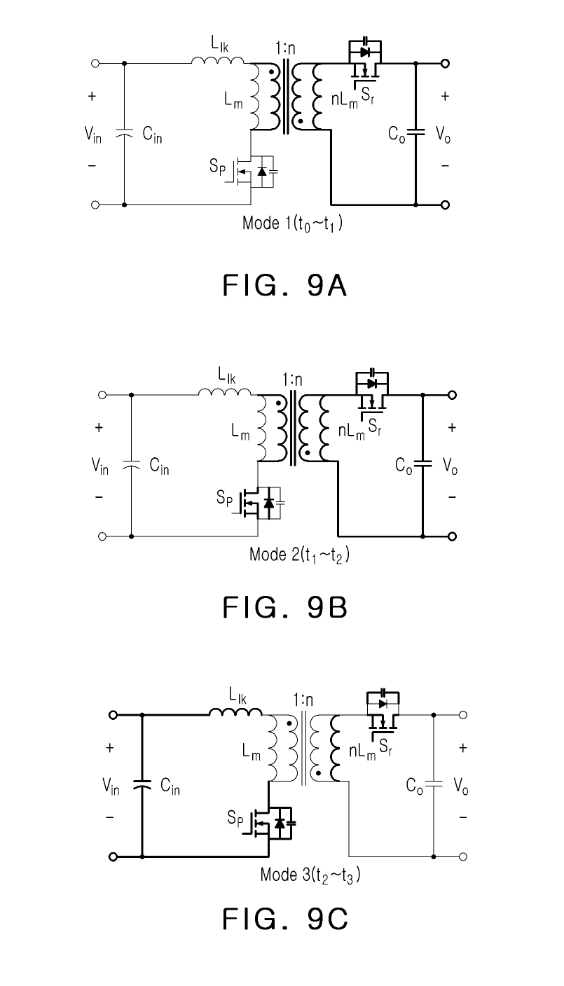

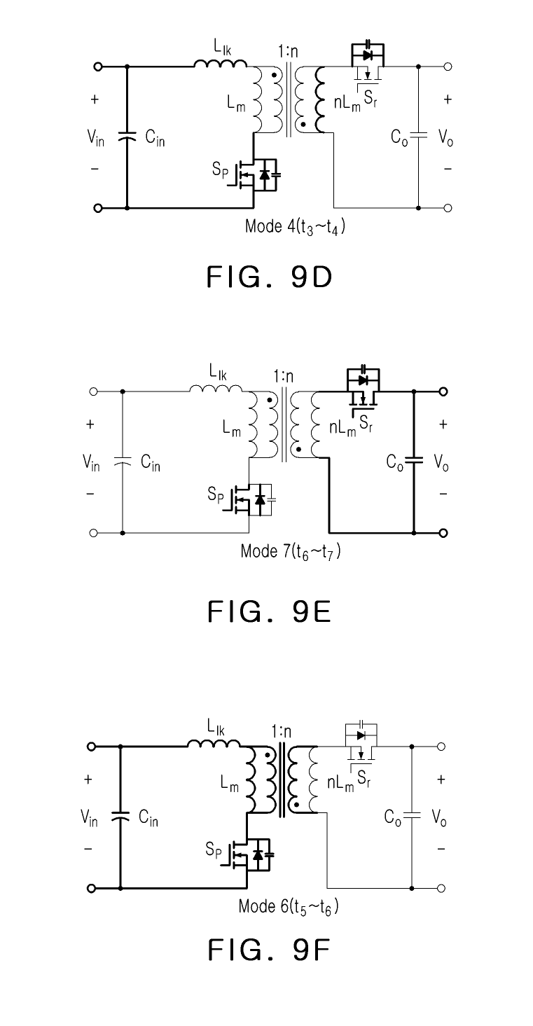

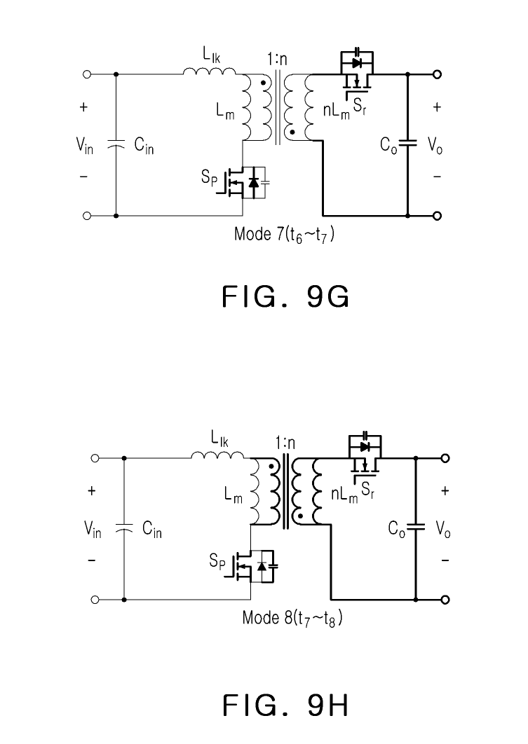

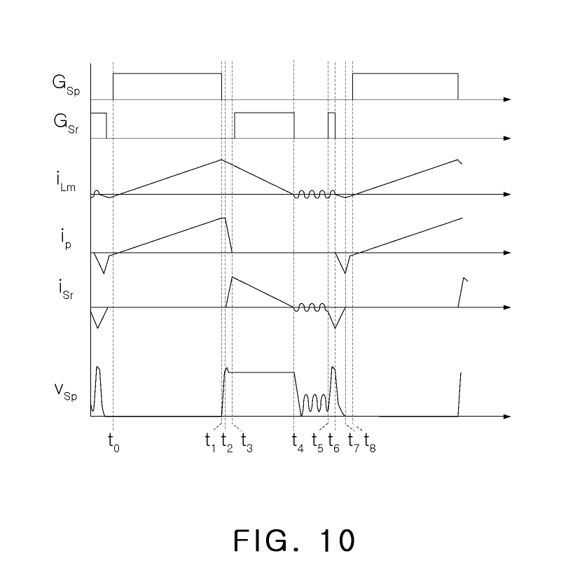

FIGS. 7A through 7H and FIGS. 9A through 9H are diagrams illustrating circuit operations for each operation mode of the solar power supply apparatus according to the embodiment of the present invention and FIGS. 8 and 10 are graphs illustrating signal waveforms of main parts in an operation mode of the solar power supply apparatus according to the embodiment of the present invention.

Referring to FIGS. 5A, 7A through 7H, and 8, at least two power supply units may be connected to each other in parallel and the output power may be coupled to one output terminal. Describing the illustrated signal waveform, the snubber switches 219 and 229 are not used and only the power switches 211 and 221 and the synchronous rectifying switches 235 and 237 may receive the same switching signals such as the illustrated waveform, as the signal waveform of the voltage periods 286, 287, and 288 of the rated voltage or less of the power switch within the system frequency. The synchronous rectifying switches 235 and 237 may perform the basic role of transferring the current transferred from the secondary winding of the transformer to a load and may improve the power conversion efficiency by replacing a diode, and are switched on by replacing the snubber switch provided in turning the snubber switch according to the related art on, thereby reducing the voltage stress applied to the power switch and reducing the switching loss.

Referring to FIGS. 5B, 9A through 9H, 10, as in the signal waveforms illustrated therein, the switching signal waveforms in the voltage periods 289 and 290 exceeding the rated voltage of the power switch within the system frequency, and the current and voltage waveforms across both terminals of the power switch, may be observed, and the switching signals operating all of the snubber switches 219 and 229, the power switches 211 and 221, and the synchronous rectifying switches 235 and 237 are provided.

As described above, according to the embodiment of the present invention, the spike voltage of the power switch may be suppressed at the high power output and the switching loss of the power switch may be reduced at the low power output, thereby improving the power conversion efficiency.

As set forth above, according to the embodiment of the present invention, the snubber switch may be selectively operated depending on the comparison result of the calculated spike voltage and the rated voltage of the power switch, and the synchronous rectifying switch may perform the switching operation, instead of the snubber switch, thereby increasing the power conversion efficiency.

While the present invention has been shown and described in connection with the embodiments, it will be apparent to those skilled in the art that modifications and variations can be made without departing from the spirit and scope of the invention as defined by the appended claims.

What is claimed is:

1. A solar power supply apparatus, comprising:
a power supply unit switching power input by a photovoltaic cell to convert power, synchronously rectifying and outputting the power converted depending on the power conversion switching, and suppressing surplus power generated by the power conversion switching in a snubbing operation; and
a control unit controlling the synchronous rectification and the snubbing operation of the power supply unit depending on a spike voltage generated by the power conversion switching.

2. The solar power supply apparatus of claim 1, wherein the power supply unit includes:
a power switch switching the input power;
a snubber switch suppressing the surplus power in a power conversion operation of the power switch; and
a synchronous rectifying switch synchronously rectifying the power converted depending on the power conversion operation of the power switch.

3. The solar power supply apparatus of claim 2, wherein the control unit compares a rated voltage of the power switch with the spike voltage depending on the power conversion switching of the power switch and selectively controls an operation of the snubber switch and an operation of the synchronous rectifying switch depending on the compared result.

4. The solar power supply apparatus of claim 3, wherein the control unit switches the synchronous rectifying switch on when the rated voltage is higher than the spike voltage and switches the snubber switch on when the rated voltage is lower than the spike voltage.

5. The solar power supply apparatus of claim 3, wherein the control unit calculates the spike voltage from the input power.

6. The solar power supply apparatus of claim 1, further comprising an inverter unit converting power output by the power supply unit into preset AC power.

7. The solar power supply apparatus of claim 1, wherein a plurality of the power supply units are connected to each other in parallel, and
at least some of outputs from the plurality of power supply units connected to each other in parallel are coupled to each other and are output.

8. A method of controlling solar generated power, comprising:
sensing power input by a photovoltaic cell;
calculating a spike voltage depending on power conversion switching of a power switch from the input power; and
comparing the spike voltage with a rated voltage of the power switch and selectively controlling an operation of a snubber switch suppressing surplus power provided in a power conversion operation of the power switch and an operation of a synchronous rectifying switch synchronously rectifying power converted depending on the power conversion operation of the power switch, depending on the compared result.

9. The method of claim 8, wherein in the controlling, the synchronous rectifying switch is switched on when the rated voltage is higher than the spike voltage and the snubber switch is switched on when the rated voltage is smaller than the spike voltage.

10. The method of claim 9, wherein the power switch, the snubber switch, and the synchronous rectifying switch are provided with a power supply unit.

11. The method of claim 10, wherein the power supply unit is provided in plural.

12. The method of claim 11, wherein at least some of output powers from the plurality of power supply units are coupled to each other.

13. The method of claim 10, wherein the output power from the power supply unit is converted into preset AC power by an inverter unit further provided therewith.
